(19) United States
(12) Patent Application Publication
(10) Pub. No.: US 2008/0277351 A1
(43) Pub. Date: Nov. 13, 2008

(54) Remediation and Reclamation of Heavy Metals From Aqueous Liquid

(75) Inventors: Gary E. Harman, Geneva, NY (US); Terry D. Spittler, Geneva, NY (US)

Correspondence Address: NIXON PEABODY LLP - PATENT GROUP, 1100 CLINTON SQUARE, ROCHESTER, NY, 14604, US

(73) Assignee: Cornell Research Foundation, Inc., Ithaca, NY (US)

(21) Appl. No.: 11/817,753

(22) PCT Filed: Mar. 2, 2006
(86) PCT No.: PCT/US06/07480

§ 371 Date: Feb. 25, 2008

Related U.S. Application Data
(60) Provisional application No. 60/658,439, filed on Mar. 4, 2005.

(51) Int. Cl. B01D 15/00; C02F 1/28

(52) U.S. Cl. 210/691

(57) ABSTRACT

The present invention is directed to a method of removing heavy or precious metal ions from an aqueous liquid. This method involves contacting the aqueous liquid with a lignocellulosic material under conditions effective to remove heavy or precious metal ions from the aqueous liquid,

This application claims the benefit of U.S. Provisional Patent Application Ser. No. 60/658,439, filed Mar. 4, 2005, which is hereby incorporated by reference in its entirety.

### FIELD OF THE INVENTION

The present invention relates to the remediation and reclamation of heavy metals from aqueous liquid.

### BACKGROUND OF THE INVENTION

Waters frequently can become contaminated with dissolved heavy metal ions, including copper, nickel, cadmium, lead, iron, uranium and others. These heavy metals need to be removed from such contaminated water to avoid undesirable health and environmental consequences. Removal of these ions to low concentrations usually is required by environmental regulations. Such contamination may occur at mining sites, industrial sites, as a consequence of contaminated discharges into waterways or other sites. This contamination may occur in large volumes of water and affect significant land areas. There frequently are few economical methods for removal of these contaminants. Oils may also contaminate waters.

A common practice used to remove metal ions in waters is by precipitation. In this process, (a) the pH of the aqueous mixture is adjusted into the alkaline range, where insoluble hydroxides of heavy metals are formed, (b) one or more flocculants are added, (c) the precipitated metal ions and flocculants are removed from the aqueous media with appropriate equipment such as a settling and clarifying equipment, followed by (d) removal of the resulting sludge and shipping to a suitable waste site. Such processes are expensive, both in terms of vessels, control systems and the costs of the chemicals involved. In some cases, an end-of-pipe (i.e. polishing) step must be used. In many cases, this involves ion exchange resins or secondary filtration. For some metals, such as chromate, the systems are even more complex, involving reduction of the chromate to chromite in acidic solutions, followed by the steps noted above. A detailed description of these processes can be found in Cushnie, “Pollution Prevention and Control Technologies for Plating Operations,” National Center for Manufacturing Sciences (1994). Some of the recovered metal is sent to metal recycling companies; from the electroplating industry alone, this totals over a million tons annually, while over one million gallons of wet sludge, containing flocculants and metals at about 10% solids, is sent to approved landfills (Cushnie, “Pollution Prevention and Control Technologies for Plating Operations,” National Center for Manufacturing Sciences (1994)). Other processes also are used, for example, using a pH-driven precipitation step, solutions of lignins are treated to cause lignin-metal complexes to precipitate. U.S. Pat. No. 6,833,123 describes precipitation of heavy metals as barium complexes. Heavy metals can be removed using adsorption on materials, such as montmorillonite, tobermorite, magnetite, and silica gel. Katsumata et al., “Removal of Heavy Metals in Rinsing Wastewater from Plating Factory by Adsorption With Economical Viabile Materials,” J. Environ. Manage. 69:187-191 (2003). A biological process is described in Lee et al., “Removal of Chromate by White Rot Fungus, Inonotus cuticularis,” J. Microbiol. Biotechnol. 12:292-295 (2002). However, these latter systems are unproven.

The prior treatment systems all are relatively inexpensive. For example, the ion exchange materials used in polishing steps typically cost more than $100 per cubic foot. The flocculating materials used in the standard precipitation process are not only expensive but the precipitate that results from these alternative methods contains only about 10% solids. Since the flocculants and other materials in the final mixture compose the majority of the solids, it is likely that that the final product is only 1-5% of the final heavy metal to be removed.

Most of the prior treatment systems are useful only in ‘pump and treat’ systems, i.e., where solutions are treated above ground. However, in some cases, subsurface water is polluted and it is desirable to treat water in situ underground.

The present invention is directed to an improved method of treating such contaminated water.

### SUMMARY OF THE INVENTION

The present invention is directed to a method of removing heavy or precious metal ions from an aqueous liquid. This method involves contacting the aqueous liquid with a lignocellulosic material under conditions effective to remove heavy or precious metal ions from the aqueous liquid.

The present invention claims certain organic materials that sorb such metals and oils from aqueous solutions and mixtures, and from which the metals or oils may be reclaimed. The organic materials are lignocellulosic materials, such as composts, barks or even manure (undigested fiber) residues. These materials may be of several types. Those which are composted are expected to have much lower levels of cellulosic and related materials since the microbial activity of the composting process will digest these. Consequently, the noncomposted materials will have lower percentages of lignins and humic substances than the composted materials. Also disclosed are variations of the present invention in which: (1) the metal-removing medium is produced on-site; (2) modifications to the state of the metal to enhance the effectiveness of the present invention; and (3) the use of plants to increase water input rates as a result of transpiration and energy production.

The method of the present invention provides a highly effective basis for large-scale removal of heavy metals from waters.

Lignocellulosic materials can be prepared for large-scale use on site. For example, mixed solid waste from a municipality could undergo thermal composting and, as a result, provide a ready source for metal removal. Alternatively, aged barks may be prepared from local lumber operations and used on site. On-site preparation of large quantities of suitable lignocellulosic materials solves both a waste disposal problem and heavy metal remediation.

The lignocellulosic materials then can be removed directly to a smelter for recovery, if desired. Alternatively, since the medium and any associated plants are organic, they can be dried and burned. This can generate energy and the ash becomes a highly concentrated ore for recovery of valuable metals.

Finally, it is noted that these media can also absorb nonpolar organic compounds, such as oils and related compounds. Thus, the present invention is suitable for removal of such compounds in waters with mixtures of metal and organic pollutants.

Thus, the process of the present invention is economically desirable for heavy metal removal and reclamation from waters. The lignocellulosic material can be prepared on site and thus generate a tipping fee from entities, such as cities, who have organic materials that require removal and processing. Second, after the lignocellulosic material is saturated with metals, it can be dried and combusted, generating energy. The lignocellulosic material used in treatment or the ash generated from that material is a valuable source of metals.

### DETAILED DESCRIPTION OF THE INVENTION

The present invention is directed to a method of removing heavy or precious metal ions from an aqueous liquid. This method involves contacting the aqueous liquid with a lignocellulosic material under conditions effective to remove heavy or precious metal ions from the aqueous liquid.

The lignocellulosic material can be from a plant source, the product of thermal or earthworm-mediated composting, an aged hardwood bark, and/or indigestible components of plants that pass through ruminant animals and that are recovered from manures or manures plus bedding materials.

There are large amounts of plant materials that are produced as by-products of economic activities but that are themselves waste materials. Many of these are lignocelluloses. Lignocelluloses are plant cell wall materials that are chemical mixtures that contain cellulose, hemicellulose, and lignins. Lignocelluloses are the most abundant polymeric renewable resource in the U.S. and probably in the world. Some of this lignocellose is used directly. For example, ruminant animals can digest some lignocellulosic plant materials to a fairly high extent, ranging from about 82% for timothy grass to only 6% for ground lodgepole pine wood. The complex lignin fraction is basically unavailable to ruminants; the limit of digestion for each material is the “digestion ceiling” so that the level of lignin determines this ceiling. Some materials, such as bark from trees removed in lumber operations, waste wood removed and shredded in land-clearing operations, and the indigestible fractions of animal feeds are all produced in large quantities. These indigestible fractions will contain high levels of lignocelluloses and can be readily composted. Once these indigestible materials are composted, they will have significantly reduced levels of complex and simple carbohydrates and amino acid-containing compounds. They will then be higher in lignins and humic substances on a percentage basis. Thus, animal digestive processes result in degradation of animal feeds but provide a high level of lignocellulosic materials along with humic substances. A secondary microbial digestion process, such as that employed in composting, will further degrade the materials to contain a high level of lignin and humic substances and remove celluloses, hemicelluloses, proteins, and other substances that are available to microbial processes (Harman et al., “Potential and Existing Uses of Trichoderma and Gliocladium for Plant Disease Control and Plant Growth Enhancement,” p. 229-265. In G. E. Harman and C. P. Kubicek (ed.), Trichoderma and Gliocladium, Vol. 2. Taylor and Francis, London (1998), which is hereby incorporated by reference in its entirety). In the case of indigestible fractions of animal feeds, some large confined animal operations collect manures as slurries and separate the liquid phase from solids. The liquid suspensions may be processed via anaerobic fermentation and spread on land. The solid materials may be collected, composted, and sold as low value horticultural supplements. However, these solid materials provide efficient media for the present invention, either in their native form or after composting. The solids that remain after anaerobic fermentation are similarly useful. Similarly, barks or woods may (a) be composted to a fine dark powder or (b) processed to make mulches. As with the composts produced from manure solids, the composts or mulches from waste wood products usually are sold to homeowners and landscapers as soil amendments or plant mulches. The mulch products may be divided further into aged mulches, where the material is piled and kept for several months, or raw mulches, which are sold directly. There exist also commercial processes that provide partial microbial degradation of certain substrates but that are much less complete than full composting. In one of these, a commercial process introduces manure solids into an aerated rotating digester. This unit uses microbial processes to heat the manures sufficiently to kill bacterial animal and human pathogens and dries the materials substantially. The result is a material that is relatively fluffy and composed primarily of plant fibers. This highly lignocellulosic material has had many of the most microbially accessible materials removed and so it is a highly desirable product for carrying out the present invention. The microbially accessible materials are removed, which is an advantage since these mostly water soluble materials will leach into waters and cause undesirable coloration and organic matter additions to water that will, for example, increase biological oxygen demand to an unsuitable level.

Another suitable lignocellulosic material is aged bark for the landscaping industry. In this process, bark (waste materials from commercial log processing operations) is placed into large piles, typically 10 m or more in height. The piles are not turned, which creates a largely anaerobic center. Highly labile soluble organic sugars and carbohydrates are removed by microbial processes, but the essential fibrous nature of the material is retained.

Composts themselves may be produced from diverse materials, including food plant wastes, manures, mixed or monolithic organic waste streams from cities or towns, or, less commonly, animal or fish wastes or flesh. Composts are also frequently formed from sewage biosolids. In this case, anaerobic digestion may be followed by composting of the separated solids, as is the case with animal composts. Typically, composting is an aerobic process and is typified by rapid microbial growth, which is turned or aerated, and held within a prescribed moisture level. Thermal composting consists of three phases. In the first phase, temperatures in the compost materials begin to rise due to microbial degradation. In the second phase, temperatures reach 40 to 65° C. due to degradation of more resistant compounds such as cellulose. At this temperature, most microorganisms die. During this time, the composts must be turned and aerated or otherwise handled in order to expose all parts to the high temperatures and ensure microbial breakdown of available substrates and a homogenous product. Once temperatures decline due to depletion of substrates, then the third or curing phase begins. During that phase, microbial recolonization occurs and humic substances increase. Typical composts are dark and consist largely of lignins, humic substances, and microbial biomass (Hoitink et al., “Status of Compost-Amended Potting Mixes Naturally Suppressive to Soilborne Diseases of Floricultural Crops,” Plant Dis 75:869-873 (1991), which is hereby incorporated by reference in its entirety). This differs significantly from the aging process that may be used with wood bark materials. In the aging process, there is no turning or aeration of the materials, and, consequently, the more resistant portions of the bark or wood retain their integrity to give a fibrous, particulate material.

A related process is conducted similarly but at some phase in the production, earthworms are introduced or become active. Typically, in this process, temperatures are kept at a lower level (less than 55° C.) and earthworm activity is fostered by inoculation. A typical process for earthworm-mediated composting is provided in U.S. Pat. No. 5,082,486 to Glogowski, which is hereby incorporated by reference in its entirety. Such products may have properties that differ from those resulting from thermal composting. In some cases, thermal composting is followed by treatment with earthworm-based systems.

The substrate and process used to produce the composted materials affect the properties of the final products. However, composted or aged products can be produced that are reasonably similar from batch to batch, particularly if the compost substrate is kept constant. However, there are significant variations between composts prepared by different methods and original substrates. Therefore, production and use of any of these materials requires characterization/quality control steps in order to obtain a consistent product.

These materials are produced in large quantities. Some of the materials, especially manure solids and wood or bark waste materials, have few uses and cost very little, typically $10-30 per cubic yard.

All of the materials just described contain humic substances. The native materials, such as barks and manures, are the least altered and contain relatively high levels of celluloses, hemicelluloses, and proteinaceous materials. After partial processing, such as the three-day manure process, or bark aging, the essential fibrous structure of the materials is retained but many of the undesirable water-soluble components are removed. Composts are modified from typical lignocellulosic starting materials and can be considered to be materials in steps along the pathways to production of coals. They have similarities with Leonardites, lignites, and peats (Ozboda et al., “Leonardite and Hunified Organic Matter,” p. 309-314. In E. A. Ghabbour and G. Davies (ed.), Humic Substances Structures, Models and Functions. The Royal Society of Chemistry, Cambridge, U. K (2001), which is hereby incorporated by reference in its entirety) in that they have higher levels of humates than do the lignocellulosic starting materials described above. Thus, the present invention includes humate ores and noncomposted biological materials, including the coals, lignites, Leonardites, peats, and other humates.

Humic substances “comprise an extraordinarily complex, amorphous mixture of highly heterogeneous, chemically reactive yet refractory molecules, produced during early biogenesis in the decay of biomatter, and formed ubiquitously in the environment via processes involving chemical reaction of species randomly chosen from a pool of diverse molecules and through random chemical alteration of precursor molecules.” MacCarthy, P., “The Principles of Humic Substances: An Introduction to the First Principle,” In E. A. Ghabbour and G. Davies (ed.), Humic Substances: Structures, Models and Functions. Royal Society of Chemistry, Cambridge, UK (2001), which is hereby incorporated by reference in its entirety.

Generally, such substances contain a hydrophobic framework of aromatic rings linked by more flexible carbon chains, with alcohol, carboxylic, carbonyl, phenolic, and quinone functional groups. They also contain a high level of bound free radicals, which increases their reactivity in the present invention. Thus, depending on pH and other parameters, they efficiently bind particular ions (Davies et al., Preface, p. vi-x. In G. Davies, E. A. Ghabbour, and K. A. Khairy (ed.), Humic Substances: Structures, Properties and Uses. Royal Chemical Society, Cambridge, UK (1998), which is hereby incorporated by reference in its entirety). Humic substances are composed of the following general fractions: humins, humic acids, and fulvic acids.

Humins are the most coal-like of the humic substances and are insoluble in aqueous solutions, regardless of pH. The humins contain more aromatic substances than the soluble fractions noted below (Davies et al., Preface, p. vi-x. In G. Davies, E. A. Ghabbour, and K. A. Khairy (ed.), Humic Substances: Structures, Properties and Uses. Royal Chemical Society, Cambridge, UK (1998), which is hereby incorporated by reference in its entirety) and, therefore, are more nonpolar. They are generally weaker water retainers, sorbents, or metal binders than humic acids and fulvic acids.

Humic acids can be dissolved in alkaline aqueous solvents and are generally insoluble at acid pHs. They contain numerous side groups.

Fulvic acids are generally smaller than humic acids and dissolve in water regardless of pH. Otherwise, they are generally similar.

As noted above, humic substances have been known for some time to have abilities to increase plant growth (Seyedbagheri et al., “Effects of Humic Acids and Nitrogen Mineralization on Crop Production in Field Trials,” p. 355-359. In E. A. Ghabbour and G. Davies (ed.), Humic Substances Structures, Models and Functions. The Royal Socieity of Chemistry, Cambridge, U. K (2001), which is hereby incorporated by reference in its entirety) and, although results have been variable, to bind metals (Logan et al., “Complexation of Cu2+ and Pb2+ by Peat and Humic Acid,” Eur. J. Soil Sci. 48:685-696 (1997), which is hereby incorporated by reference in its entirety), and to absorb nonpolar compounds (Xing, B., “Nonlinearity and Competitive Sorption of Hydrophobic Organic Compounds in Humic Substances,” p. 173-183. In G. Davies, E. A. Ghabbour, and K. A. Khairy (ed.), Humic Substances Structure Properties and Uses. The Royal Society of Chemistry, Cambridge, UK (1998), which is hereby incorporated by reference in its entirety). In some cases, additions of composts and municipal waste biosolids to soil has reduced phyto- and bioavailability of heavy metals, such as copper, nickel, lead, zinc, and cadmium (Brown et al., “In Situ Soil Treatments to Reduce the Phyto- and Bioavailability of Lead, Zinc and Cadmium,” J. Environ. Quality 33:522-531 (2004) and Killila, et al., “In Situ Bioremediation Through Mulching of Soil Polluted by a Copper-Nickel Smelter,” J. Environ. Quality 30:1134-1143 (2001), which are hereby incorporated by reference in their entirety). Thus, plants can be established in soils that are otherwise toxic due to heavy metal contamination (Brown et al., “Using Municipal Biosolids in Combination with Other Residuals to Restore Metal-Conaminated Minining Areas,” Plant and Soil 249:203-215 (2003) and Li et al., “Response of Four Turfgrass Cultivars to Limestone and Biosolids-Compost Amendment of a Zinc and Cadmium Contaminated Soil,” J. Environ. Quality 29:1440-1447 (2000), which are hereby incorporated by reference in their entirety).

As noted infra, some of the materials with the highest sorption capabilities are relatively slightly modified lignocellulosic substances. In part, this is expected to result from the fact that they retain the original cellular structure and so their sorption can occur both on the exterior of particles and on the interiors of the residual cellular structures.

The heavy or precious metal ions, treated in accordance with the present invention, can be copper, nickel, lead, iron, zinc, cadmium, mercury, uranium, gold, silver, chromium, molybdenum, antimony, other metals having an atomic weight greater than or equal to 58 (e.g., nickel), and/or mixtures thereof.

The pollutants to be removed include dissolved heavy metals in water. Soluble metals at objectionable levels frequently occur as dissolved salts at sites of mines, factories, and other locations. These metals are frequently difficult or expensive to remove and toxic to people and damaging to the environment. Metal contaminated waters may include ions of copper, zinc, nickel, lead, cadmium, mercury, uranium, or others. All have toxicity to animals, plants, and other organisms or may deleteriously affect sensitive environments. Even more innocuous materials may have very low limits for discharge under certain conditions. For example, in some situations, the discharge limit for iron is 1 ppm. Mining operations may have as contaminants traces of gold, silver, or other precious metals, as well as cyanide conjugates of such metals. Frequently, they are mixed with other ions, including less toxic sodium, potassium, magnesium, and others, and may be present at various pH levels. Acid mine drainage may be particularly vexing, because pH levels may be low (i.e. 1-2), and these acids may be corrosive and toxic in themselves. Other contaminants may be present, including metallocyanides and organic compounds. Polluted water systems may be relatively simple, with predominately one or a few metals, or more complex.

The lignocellulosic materials of the present invention are expected to be highly effective for large-scale amelioration of contaminated waters. The removal may be accomplished by passing the metal-containing water through the selected materials contained in a column system, an open vessel or even as a berm or other pile of material. Control systems for this purpose may be rudimentary or highly sophisticated.

The lignocellulosic materials for metal removal may be ground and/or screened to provide a material with a relatively homogenous size distribution. Though not essential, such pre-treatment of the lignocellulosic material makes the treatment of aqueous liquids in accordance with the present invention more efficient and uniform.

Heavy metal polluted water can be applied to the lignocellulosic materials in a column, open vessel, trench, berm, silo, or other configuration.

Lignocellulosic materials with high levels of humic acid can burn readily. Thus, after contaminants are absorbed or recovered, the resulting material may be disposed of by burning in an appropriate facility, with valuable metals recovered from the ash. The level of absorption of metals by the lignocellulosic material is about 4% on a weight basis, so such ash by-products would be a valuable metal ore. As noted in the Examples, absorbed metals are so tightly bound to the lignocellulosic material that they pass TCLP (Toxicity Conversion Leaching Procedure). As a result, the noncombusted metal-complexed lignocellulosic materials may be disposed of in a standard landfill.

The lignocellulosic materials of the present invention can be used for economical removal of oils and other apolar compounds from surfaces and waters. Thus, these materials can be used for removal of both heavy metals and apolar compounds (such as oils), which are present as contaminants in the aqueous liquid being treated.

Lignocellulosic materials, which are particularly useful in accordance with the present invention, specifically bind and remove heavy metals from solution but that do not remove small monovalent cations to the same degree. This distinction is a highly useful one, because some metal-contaminated waters may contain both nontoxic, relatively nonpolluting monovalent cations. Thus, if both heavy metals and monovalent cations were sorbed from aqueous solutions, then the competitive binding of the monovalent ions, if present in high concentration, could prevent the binding of toxic heavy metal ions. Specifically, in accordance with the present invention, lignocellulosic materials that remove at least 100 μmoles of copper from a copper sulfate solution in deionized or distilled water but at least 5-fold less potassium from a similar solution of potassium chloride per gram of lignocellulosic materials are used. A useful method of testing such removal is by mixing 5 g dry weight of the humic substances with 1.5 mmoles of the test salt dissolved in deionzed or distilled water in an Erlenmeyer flask. The mixture is placed on a rotary shaker (100 rpm) overnight. The solids and liquid are then separated by centrifugation or filtration and the concentration of the metals in the supernatant is then determined by atomic absorption or other appropriate methods.

Tree bark is a preferred lignocellulosic material. Such materials may be aged by placing ground bark in a pile where primarily anaerobic microbial processes cause significant heating and degrade free sugars and other similar materials. Typically, aged barks are readily available from sellers of landscaping products as mulches for plants.

As noted supra, composts and related materials contain both water-soluble and insoluble materials. In one embodiment of the present invention, the most useful materials are those whose water soluble components (humic and fulvic acids) are precipitated and thereby rendered insoluble by reaction with heavy metal ions. This precipitation prevents both the release of chelated heavy metals and also of potentially polluting organic “brown waters” that are objectionable components of composts and related materials when added to the environment. Another method to reduce the objectionable “brown waters” is to use either the partial microbial digestion processes (e.g., aged hardwood bark or the 3-day digested manures), which leaves the structural integrity of the original products intact, or a full composting process that degrades the materials typically to a brown, relatively fine particulate material with high levels of humic substances (Harman et al., “Potential and Existing Uses of Trichoderma and Gliocladium for Plant Disease Control and Plant Growth Enhancement,” p. 229-265. In G. E. Harman and C. P. Kubicek (ed.), Trichoderma and Gliocladium, Vol. 2. Taylor and Francis, London (1998), which is hereby incorporated by reference in its entirety).

Further, some metals, such as chromium, frequently are present as oxides such as CrO₄⁻. This is highly toxic form of chromium (Cr⁺⁶). Since the chromate ion is negatively charged, the lignocellulose materials of the present invention do not remove it from solution except at acidic pH levels (below about pH 3).

It is recognized that the pH of the aqueous solution may adversely affect binding of heavy metals to humic substances and composts since acidic conditions reduce ionization of acid groups (Kretzschmar et al., “Proton and Metal Cation Binding to Humic Substances in Relation to Chemical Composition and Molecular Size, p. 153-163. In E. A. Ghabbour and G. Davies (ed.), Humic Substances Structures, Models and Functions. Royal Society of Chemistry, Cambridge, U.K. (2001), which is hereby incorporated by reference in its entirety). In carrying out the method of the present invention, the pH of the aqueous liquid can be adjusted to 5.5 or above prior to contacting the aqueous liquid with the lignocellulosic material. This can be carried out by contacting the aqueous liquid with limestone or an agent effective to neutralize acid waters. For example, composts that are fortified or admixed with lime or other alkaline materials to facilitate effective metal binding are useful in accordance with the present invention.

The method of the present invention can also include reducing metal oxides in the aqueous liquid to cations prior to contacting the aqueous liquid with the lignocellulosic material. This reduction of metal oxides is achieved by contacting the aqueous liquid with a metabisulfite or a ferrous ion.

In a preferred embodiment, plants can be grown proximate to the lignocellulosic material. Such plants can be capable of high transpiration rates, accumulating metal, and degrading cyanides or metallocyanides and/or sequestering metals in the presence of water containing cyanide-conjugated metals. Examples of plants with high transpiration rates include willow (Ebbs et al., “Transport and Metabolism of Free Cyanide and Iron Cyanide Complexes by Willow,” Plant Cell Environ. 26:1467-1478 (2003), which is hereby incorporated by reference in its entirety) or cottonwood trees. It is important that water be applied to the plants at such a rate as will avoid water-logging or saturation of the lignocellulosic material. In precious metal mining, one embodiment of the present invention is to contact water containing cyanide-conjugates and precious metals with the lignocellulosic material and to use the combination of plants and root-colonizing fungi to degrade the cyanide. Fungi are known that colonize willow roots and degrade cyanides (Harman et al., “Uses of Trichoderma spp. to Remediate Soil and Water Pollution,” Adv. Appl. Microbiol. 56:313-330 (2004), which is hereby incorporated by reference in its entirety). The lignocellulosic material that is used in accordance with the present invention will bind the metals for recovery. Regardless of plant additions, the lignocellulosic material will eventually become saturated so that it cannot sorb more metals. In particular, the lignocellulosic material, after being used in accordance with the present invention, would be expected to contain more than 1% dry weight of metal ions.

After carrying out the process of the present invention, the lignocellulosic material and any plants growing proximate to the lignocellulosic material can be harvested and the harvested material is combusted. Where the aqueous liquid contains precious metals, such metals can be recovered from the ash resulting from combustion of harvested materials.

### EXAMPLES

### Example 1

### Materials and Methods

In the experimental work that underlies the present invention, a variety of composts and similar substances have been used as follows:

Andre Compost: This material was prepared by Andre Farms, Wauseon, Ohio by thermal composting of mixed yard and plant wastes.

Earthworm-Mediated Compost: This material was prepared from mixed yard wastes and similar materials by the process described in U.S. Pat. No. 5,082,486 to Glogowski, which is hereby incorporated by reference in its entirety.

Geneva Municipal Sludge Compost: This material was prepared by the city of Geneva, N.Y. The process consists of dewatering of sewage sludge from an anaerobic fermentation, mixing with hardwood sawdust, and then thermally composting with aeration in a silo and secondarily in piles that were turned periodically.

Milorganite: Milorganite is a commercial product sold for home garden and golf course use as a soil conditioner. It is prepared from Milwaukee, Wis. sewage sludge. The exact process is not known but is believed to be at least somewhat similar to the Geneva municipal sludge compost.

Mushroom Compost Mushroom compost is the material that remains after culture and harvest of mushrooms, mostly Agaricus spp. The mushroom growing process is itself a composting process; the starting materials are horse manure and straw.

Arkport Sandy Loam Control: A sandy loam soil with less than 1% organic matter was used as a control with a low level of humic substances.

Dewatered Dairy Cow Manure: Large dairy farms and other contained animal facilities must deal with copious quantities of manure. One method of dealing with this is to suspend the manure and urine in water and then to separate the solids and the liquids. The solids are separated from the liquids by appropriate compression equipment, and the dewatered manure is conveyed to another location for disposal or processing. It should be noted that the cow-processed materials will be rich in lignins and humates, because these are the indigestible parts of the plant based feeds. This material, when dried, is particulate, light tan in color, and free of objectionable odors. The material used in these tests was obtained from the Fessenden Dairy, LLC, King's Ferry, N.Y. Hereafter, this material is referred to as indigestible plant residues. A similar material that has been processed through the three day rapid composting process will be referred to here as processed indigestible plant residues. These materials are tan and retain the particulate, fibrous nature of the plants from which it was derived.

Cow Manure Compost: The same material as described above is frequently subjected to standard thermal composting, to give a product that is primarily used as a horticultural soil amendment. This material was also obtained from the Fessenden Dairy and is a dark brown in color, finely particulate, and no longer resembles the plant materials from which it was derived.

Aged Hlardwood Bark: Hardwood bark was obtained from local sawmills by Sensenig's Mulch and Landscaping, Geneva, N.Y. This material was placed in large piles and allowed to age for several months. The resulting dark brown material could be ground to any desired size and sold as a mulch for plants.

Aged Ground Wood: A similar mixture composed of the entire biomass from forest clearing operations was obtained by grinding the stumps and stems of trees and then aging.

General Experimental Protocol: The general experimental protocol in all cases was similar. The materials tested in initial experiments were copper (i.e. copper sulfate); nickel (i.e. nickel sulfate); magnesium (i.e. magnesium sulfate); and potassium (i.e. potassium sulfate). Thirty ml of these solutions, or mixtures of them, were added to 125 ml Erlenmeyer flasks and 5 g (dry weight) of the composts or soil was added to each. The mixtures were placed on a rotary shaker overnight, the solid and liquid fractions were separated, and the level of metals remaining in the liquid phase of the mixtures was assayed using atomic absorption.

### Example 2

### Removal of Individual Metals

Individual metal salts were added to thirty ml of water and to this was added 3 or 6 g of material. However, two of the materials (i.e. the indigestible plant residues and the aged hardwood bark) had very high water holding capacities. Therefore, it was necessary to use 50 ml of test solution. The data from the original flask is the value determined by atomic absorption; it did not contain any lignocellulosic materials. The results reported are from a representative experiment; the general experiment was conducted twice. The results are set forth in Table 1 as follows (values in ppm):

TABLE 1

| | | Cu + 2 | | Mg + 2 | | Ni + 2 | | K + 1 | |
|---|---|---|---|---|---|---|---|---|---|
| Material | | PPM | pH | PPM | pH | PPM | pH | PPM | pH |
| Arkport | 3 g | 2950 | 3.9 | 3450 | 7.5 | 2900 | 6.8 | 3800 | 6.3 |
| Arkport | 6 | 2900 | 3.8 | 3350 | 7.6 | 3000 | 6.5 | 3800 | 6.2 |
| Milorganite | 3 | 1200 | 4.1 | 3850 | 6 | 1700 | 6 | 3200 | 6.45 |
| Milorganite | 6 | 850 | 5 | 2950 | 6.2 | 1000 | 5.9 | 3700 | 6.4 |
| Andre | 3 | 180 | 5.3 | 2750 | 6.9 | 900 | 6.7 | 4700 | 7.3 |
| Andre | 6 | 80 | 5.8 | 3000 | 6.95 | 200 | 6.9 | 6000 | 7.2 |
| HemlockBark | 3 | 2350 | 3.9 | 3250 | 6.5 | 2100 | 6.4 | 3500 | 5.8 |
| Hemlock Bark | 6 | 2250 | 4 | 3000 | 6.6 | 2000 | 6.1 | 3500 | 5.7 |
| Geneva SS | 3 | 1600 | 4 | 3500 | 6.1 | 2000 | 5.5 | 3500 | 5.85 |
| Geneva SS | 6 | 710 | 4.1 | 3250 | 6.2 | 1300 | 5.4 | 4100 | 5.85 |
| Aged Hardwood bark | 3 | 1150 | 4.2 | 2900 | 6.4 | 1600 | 5.9 | 4400 | 6.5 |
| Aged hardwood bark | 6 | 900 | 4.3 | 3000 | 6.5 | 1300 | 5.9 | 3800 | 6.4 |
| Aged Pine | 3 | 2150 | 2.9 | 3250 | 3.7 | 2300 | 3.9 | 4000 | 3.8 |
| Aged Pine | 6 | 1500 | 3.3 | 3150 | 3.7 | 2300 | 3.6 | 4000 | 3.7 |
| Indigestible plant resid. | 3 | 1100 | 4.8 | 3500 | 7.3 | 1500 | 6.7 | 5000 | 7.3 |
| Indigestible plant resid. | 6 | 860 | 5 | 3250 | 7 | 1500 | 6.8 | 4500 | 7.2 |
| Mushroom compost | 3 | 230 | 4.8 | 2750 | 7 | 500 | 6.4 | 5200 | 6.75 |
| Mushroom compost | 6 | 150 | 4.9 | 2500 | 6.9 | 100 | 6.4 | 6200 | 7 |
| Original Solution | | 2950 | 4 | 3000 | 7.2 | 2800 | 7.5 | 4900 | 6.6 |

In this and all other experiments, smaller divalent or monovalent ions from alkali or alkali earth metals were inefficiently removed. In the experiment reported above, removal of nickel was variable with these test materials. Removal of copper was also variable. This was somewhat expected because the pH of the original solution was acidic, only at pH 4. It is to be expected that the hemicellulosic or humate containing materials will be ineffective at acidic pH levels, because ionic groups in the materials will be poorly dissociated at this pH level. The results with the various materials and nickel also were variable.

Given the variable results with copper at low pH levels, solutions where the pH of the solutions was adjusted by the addition of solid calcium carbonate were tested. The results are presented in Table 2 as follows.

TABLE 2

| | Amount | | | |
|---|---|---|---|---|
| | CaCO₃ | pH w/ | pH w/o | |
| Material (3 g) | (grams) | CaCo₃ | CaCo₃ | ppm Cu |
| Hemlock | 0.1 | 5.5 | 4.8 | 165 |
| Hemlock | 0.3 | 5.6 | | 35 |
| Hemlock | 0.5 | 5.7 | | 15 |
| Hemlock | 0.8 | 5.75 | | 15 |
| Hemlock | 1 | 5.85 | | 15 |
| Aged Pine | 0.1 | 5.6 | 3.5 | 50 |
| Aged Pine | 0.3 | 5.85 | | 30 |
| Aged Pine | 0.5 | 6.05 | | 20 |
| Aged Pine | 0.8 | 6.1 | | 25 |
| Aged Pine | 1 | 6.1 | | 25 |
| Aged hardwood bark | 0.1 | 6.1 | 5.7 | 35 |
| Aged hardwood bark | 0.3 | 6.2 | | 25 |
| Aged hardwood bark | 0.5 | 6.25 | | 30 |
| Aged hardwood bark | 0.8 | 6.25 | | 25 |
| Aged hardwood bark | 1 | 6.25 | | 25 |
| Andre | 0.1 | 6.7 | 6.6 | 10 |
| Andre | 0.3 | 6.7 | | 10 |
| Andre | 0.5 | 6.7 | | 9 |
| Andre | 0.8 | 6.7 | | 9 |
| Andre | 1 | 6.7 | | 11 |
| Original solution | | 4.2 | | 1100 |

In this experiment, cupric ions were very effectively removed, with overall efficiencies of greater than 99%. These data demonstrate that pH is an important factor for the usefulness of the present invention and that it must be greater than pH 5.5.

Conversely, smaller divalent or monovalent ions from alkali or alkaline earth metals, like magnesium and potassium, were inefficiently removed. This ability of composts to preferentially remove and sorb heavy metals, as opposed to small molecular weight materials, is an important embodiment of the present invention.

The amount of heavy metals, by weight, that was removed from solution was calculated. Assuming all of the removed metals were bound into the composts, the amount of copper bound to the medium was about 0.9% by weight of the compost-metal ion conjugate (cupric ions in Table 2 with hardwood bark). In other experiments, the level of copper bound was 1.8%. Clearly, the materials were not saturated, so the actual holding capacities are greater than this level. Thus, the composted materials+copper constitute a metal ore with about 2% copper by weight. With nickel, the amounts would be slightly less.

The check soil and Arkport sandy loam were largely ineffective at metal removal, as expected. The Geneva compost was substantially less effective at metal removal than the Andre composts, and mushroom composts.

Another experiment was conducted to verify the above results and to extend the data to include lead (from lead acetate). It also tested the question of whether the metals were removed from solutions by the water soluble or insoluble fractions of the lignocellulosic materials. For this purpose, 50 g of each material (dry weight equivalent) was screened through an 8 mesh screen and added to 200 ml of water in an Erlenmeyer flask. The mixture was shaken at 100 rpm overnight, and the liquid and the particulate fractions were separated by centrifugation. This mixture resulted in an acceptable pH level for copper. This process was repeated two more times with an additional 100 ml of water. The washed fractions were then tested and yielded the results set forth below in Table 3.

TABLE 3

parts per million

| treatment | Cu | Ni | Mg | Pb |
|---|---|---|---|---|
| Andre compost | 20 | 200 | 467 | 30 |
| Andre compost washed | 40 | 250 | 337 | 30 |
| Arkport sandy loam | 1700 | 1700 | 444 | 3200 |
| Arkport sandy loam washed | 1700 | 1550 | 422 | 3000 |
| Geneva compost | 370 | 700 | 467 | 43 |
| Geneva compost washed | 400 | 600 | 319 | 40 |
| Mushroom compost | 20 | 250 | 337 | 40 |
| Mushroom compost washed | 20 | 200 | 422 | 50 |
| Original solution | 2600 | 1850 | 551 | 3000 |

These results again demonstrate that the smallest ion, Mg, was not efficiently removed but that significant amounts of copper, nickel, and lead ions were removed from the solutions by the Andre and mushroom composts. The municipal compost from Geneva, N.Y., was less effective in removing copper and nickel than Andre or mushroom composts. On the other hand, the Geneva compost did effectively remove lead from solution. The washing step did not substantially reduce the composts' ability to remove metal ions from solutions, even though some of the washings were very darkly colored brown, indicating the removal of significant quantities of humic substances.

### Example 3

### Tests with Mixture of Metals

The present invention was also experimentally tested with mixtures of the metals. Here, composts with no metals were used to discern the background levels of metals that might be extracted from them. The results are set forth in Table 4 as follows:

TABLE 4

| | | PPM | PPM | PPM | PPM | |
|---|---|---|---|---|---|---|
| COMPOST | WEIGHT | Ni | Cu | K | Mg | pH |
| Arkport | 3 | 740 | 750 | 920 | 972 | 5.3 |
| | grams | | | | | |
| Arkport | 6 | 770 | 750 | 920 | 918 | 5.15 |
| Milorganite | 3 | 410 | 740 | 1000 | 1296 | 5.8 |
| Milorganite | 6 | 290 | 740 | 1000 | 972 | 6 |
| Andre | 3 | 120 | 10 | 2000 | 1080 | 6.5 |
| Andre | 6 | 40 | 15 | 3200 | 1080 | 6.95 |
| HemlockBark | 3 | 730 | 390 | 920 | 972 | 5 |
| Hemlock Bark | 6 | 650 | 190 | 940 | 918 | 4.8 |
| Earthworm-mediated | 3 | 190 | 10 | 820 | 972 | 5.8 |
| compost | | | | | | |
| Earthworm-mediated | 6 | 40 | 5 | 800 | 972 | 6.2 |
| compost | | | | | | |
| Geneva SS | 3 | 500 | 100 | 820 | 810 | 5.05 |
| Geneva SS | 6 | 340 | 40 | 750 | 864 | 5.2 |
| Premium HW mulch | 3 | 460 | 90 | 940 | 918 | 5.4 |
| Premium HW mulch | 6 | 390 | 55 | 940 | 864 | 5.5 |
| Aged Pine | 3 | 680 | 470 | 1300 | 810 | 3.6 |
| Aged Pine | 6 | 570 | 280 | 940 | 864 | 3.6 |
| Indigesible plant res. | 3 | 370 | 45 | 1300 | 864 | 6.95 |
| Indigesible plant res. | 6 | 340 | 40 | 1400 | 972 | 7.1 |
| Mushroom | 3 | 140 | 70 | 2100 | 864 | 6.4 |
| Mushroom | 6 | 60 | 65 | 3300 | 864 | 6.6 |
| Original Solution | | 700 | 930 | 1230 | 864 | 5.5 |

The data in Table 4 are supportive of the earlier data with single materials. The small molecular weight metal ions, like potassium and magnesium, were inefficiently removed. Similarly, the ineffective materials with all metals, the Arkport sandy loam and Milorganite, were ineffective in this trial. The Arkport sandy loam, at least, has ahnost no organic material, so it would have been expected to be ineffective. The Milorganite has been modified from its original composition and apparently this caused it to be ineffective. However, copper was effectively removed by all materials, although the aged pine bark was less effective, probably because its acidic nature caused the overall pH level to be below effective values. Nickel was removed less effectively than copper. The effective lignocellulosic materials had a clear preference for the metal ions in the following order: copper>nickel>magnesium, or potassium.

The solutions from the composts alone were yellow to brown, indicating a substantial presence of humic and fulvic acids. However, in the presence of metals, the solutions largely lacked color. It was observed independently that the salts of the heavy metals precipitated the colored compounds, which, as noted earlier, is an important aspect of the present invention.

The above experimental work was repeated using higher levels of composts—10 vs 5 g of composts, per experiment, primarily to determine if this would increase the efficacy of removal of nickel ions. The results are set forth in Table 5 as follows:

TABLE 5

| | | parts per million | | | |
|---|---|---|---|---|---|
| wt (g) | compost | Mg | K | Ni | Cu |
| 5 | Andre compost | 940 | 3300 | 1625 | 50 |
| 10 | Andre compost | 980 | 4400 | 825 | 40 |
| 5 | Geneva compost. | 580 | 1500 | 2650 | 950 |
| 10 | Geneva compost | 680 | 1800 | 2750 | 750* |
| 5 | Arkport sandy loam | 760 | 1700 | 2900 | 2050 |
| 10 | Arkport sandy loam | 780 | 1600 | 2700 | 2400 |
| 5 | Mushroom compost | 840 | 4000 | 1125 | 50 |
| 10 | Mushroom compost | 860 | 5700 | 285 | 40 |
| 5 | Milorganite | 820 | 2100 | 2375 | 700 |
| 10 | Milorganite | 860 | 2400 | 1675 | 650 |
| | metal solution | 600 | 1500 | 2800 | 2200 |

These results indicate that neither Mg or K was effectively removed from solution by any of the materials but that nickel and copper were removed. The increase in compost levels from 5 to 10 g increased the efficacy of nickel removal markedly. Thus, the composts can effectively remove heavy metals, but not smaller ions such as magnesium or potassium. This differential effect is an important component of the present invention. Further, the municipal composts were much less effective than the Andre or mushroom composts. The Arkport sandy loam control had little or no ability to remove metals from solutions.

### Example 4

### Effective Removal of Fe⁺² Ions from Water

As noted supra, even relatively nontoxic materials, such as iron, in water may be of concern. Therefore, the ability of various lignocellulosic materials to remove Fe⁺² ions from water was tested. A solution of FeSO₄ that contained 3000 ppm of Fe⁺² was prepared. To 30 ml aliquots of this solution (90 mg total) was added various lignocellulosic materials and the mixture was shaken overnight and filtered. The results are recorded in Table 6 as follows:

TABLE 6

| | | Fe remaining | | | Binding |
|---|---|---|---|---|---|
| | Amount | (3000 ppm | | | capacity |
| Material | Tested | originally | | % Removal | (%) |
| Andre compost | 3 g | 5 | ppm | 99.8% | 3% |
| Geneva | 3 g | 13.5 | ppm | 95.5% | 2.8% |
| compost | | | | | |
| Hardwood bark | 2 g | 4 | ppm | 99.9% | 4.5% |
| Aged wood | 3 g | 4 | ppm | 99.9% | 2.8% |
| Indigestible | 2 | 46 | ppm | 90.5% | 2.7% |
| plant residues | | | | | |

These results show that all materials are effective in removal of ferrous ions from water and that the total of what was absorbed in this experiment was as much as 4.5% of the ions per g of material. Further, it is evident that this batchwise experiment will be much less effective in removal of metal ions from solution than if similar materials were passed through a column. Examples 5-6 address this point.

It is apparent that, while all materials tested were effective, some were more effective than others. Aged hardwood bark worked particularly well.

### Example 5

### Removal of Chromate

As noted earlier, chromium frequently present in water is in the form of the highly toxic oxide of Cr⁺⁶, CrO₄. Examples 3-4 describe removal of positively charged metal ions (cations); however, oxidized forms of some metals exist as anions. Such anions, including chromate and salts of uranic acid, can be removed from solution by the process of the present invention. Since charge is one of the methods by which lignocellulosic materials remove metal ions from solutions, this distinction is important. It is expected in the lignocellulosic materials that positively charged sites or domains will be ionized at acidic pH levels and that negatively charged sites or domains will more frequently be ionized at higher pH levels. Therefore, an experiment was conducted in which a solution containing about 35 ppm of chromate obtained from a polluted site was used as the test material. The results of this experiment are set forth in Table 7 as follows, with the test protocol being essentially the same as that described supra following adjustment of pH of the mixture to the levels indicated:

TABLE 7

| | | Cr remaining | |
|---|---|---|---|
| | | (35 ppm | |
| Material | Amount Tested | originally | % Removal |
| EC001 pH 7 | 3 g | 10.3 ppm | 71% |
| EC001 pH 3 | 3 g | 3.9 | 89% |
| Indigestible | 2 g | 12.5 | 64% |
| plant residues | | | |
| pH 8.3 | | | |
| Indigestible | 2 g | 3.9 | 89% |
| plant residues | | | |
| pH 3 | | | |
| Geneva compost | 3 g | 16.5 | 53% |
| pH 7.1 | | | |
| Geneva compost | 3 g | 5.3 | 85% |
| pH 3 | | | |

In these tests, EC001 is a commercial composted material from Restoration Soil and Research, State College, Pa. These results demonstrate that removal of CrO⁴⁻ can be accomplished with the lignocellulosic materials of the present invention; however, the efficacy of such removal is much less than with metallic cations. Reduction in pH of the test material improves efficacy, but, even with such pH reduction, efficacy with anions is still much lower than for cations.

### Example 6

### Efficient Removal of Chromate from Contaminated Water

Given these results, methods for altering metal oxides to positively charged metal cations were developed. As noted earlier, chromium in water is frequently present as the highly toxic oxide of Cr⁺⁶, CrO₄⁻. The standard commercial process for removal of chromate from contaminated water includes: (1) reduction of the chromate to chromite (Cr⁺³) in acidic conditions; (2) raising the pH to alkaline conditions; (3) adding flocculating agents and other materials to cause efficient precipitation; and (4) harvesting the precipitate by a suitable means. This is an expensive-process requiring stainless steel vessels and significant costs in chemicals.

The process of the present invention is simpler and involves the following steps: (1) reduction of chromate to chromite in acidic conditions; (2) in-line adjustment of pH to 6.7-7.1; and (3) passage through a column or other vessel filled with the absorptive lignocellulosic material.

Efficacy was demonstrated by the following trials:

Trial 1:

A sample of water from polluted ground water that contained about 35 ppm chromate was obtained. The pH was adjusted to 3.3-3.5 with nitric acid, and chromate was reduced by addition of 0.85 g Na₂S₂O₅ (sodium metabisulfate) per liter. The reduced and acidified material was pumped at a rate of 8-10 ml/min, and Na₂CO₃ was added in-line to adjust the pH to 6.7-7.1; a minimum pH of 6.9 is preferred.

The treated sample was added to a column (5×25 cm, 500 ml total volume) that was filled with 151 ml aged hardwood bark on a 3 mm crushed limestone bed. The aged hardwood bark sized between 8 (2.35 mm) and 35 mesh (0.5 mm). The bark matrix was moistened by pumping water into it by reverse flow until water emerged from the column. The relatively large particle size of the material in the column provides a packing with relatively large void spaces. The matrix does not swell appreciably when moistened, so there is essentially no back pressure.

The column was run at 8-10 ml/min (9 ml average) with the reduced pH and pH adjusted chromite solution. Assuming a void volume of appx. 50%, the transit time was about 28 minutes.

The total volume passing through the column without breakthrough was 38 L, for a total amount of material absorbed onto the matrix of 1.22 g. Cr levels in the effluent were consistently below 1 ppm. After the 38 L passed through the column, the column was rinsed with two volumes of water, drained, and the matrix was recovered. The resulting matrix material was dried and then subjected to TCLP analysis, which it passed.

Trial 2

In Trial 1, even after 38 L was passed through the column, breakthrough (i.e. leaching of chromium above 1 ppm into the effluent) was not observed. Therefore, to obtain information on total column loading capacity, a column containing aged hardwood bark was prepared as noted above except that the bed support was glass beads rather than crushed limestone. A solution of CrCl₃×6H₂O was prepared to contain 135 ppm Cr. To the solution was added 0.14 g Na₂S₂O₅. This was done in order to provide a reduced solution to mimic the response that would be present in actual samples and because, in the absence of the bisulfite, the Cr precipitated even at relatively low pH values. The Cr solution was pumped into the column and the pH was adjusted in transit to be between 6.9-7.1 with sodium bicarbonate (the pH of the original chromium chloride solution was 3.8). The column was run in reverse flow at an average rate of 3 ml/minute, so the total transit time was about 83 minutes. The Cr levels in the effluent were consistently below 1 ppm but, at 5 ml per minute, there were 3-4 ppm of Cr in the effluent. The total volume of 135 ppm Cr solution applied to the column was 38.8 L, for a total of about 5.2 g of Cr. Thus, the average column loading was about 3.9% by weight of Cr on the matrix. However, after about 35 L of Cr solution passed into the column, a gray precipitate typical of CrOH₃ (or perhaps Cr[HCO₃]) appeared at the bottom of the column. This indicates that at this lower layer, the matrix became saturated and excess Cr precipitated. The column was taken down and both the precipitate layer and the upper nonprecipitated layer were subjected to TCLP analysis, with both passing.

Trial 3

Other methods can be used to reduce chromate to chromite and efficiently remove the chromite columns packed with lignocellulosic materials. Fe⁺² is an efficient reducing agent, and this ion is efficiently bound to aged hardwood bark and other media. In this embodiment of the present invention, the sodium metabisulfite reduction step was omitted. Instead, a column of 20 cm³ (11.3 g) was packed with aged hardwood bark as previously described, and a solution of FeSO₄ (100 mM) was pumped onto the column with reverse flow until the water emerged from the top of the column. Then, a chromate solution (25 ppm Cr) was obtained from a polluted water source and pumped onto the iron-charged column at 1 ml/min. In addition, a solution of 10 ppm of FeSO₄ was added concurrently with the chromium solution to the bottom of the column. About 3.3 L was added with no chromate breakthough in the effluent detected. The amount of Cr that was bound to the column was about 0.7%, which is less than that in the other two trials.

This system has two other disadvantages. The Fe⁺² in the column oxidizes to insoluble Fe⁺³ and creates column plugging and fouling problems. In addition, while Cr is effectively removed from polluted water, Fe does exit the column, and, in some applications, this is objectionable. Thus, the use of Fe⁺² as an in-column reducing medium is a less preferred embodiment of the present invention. However, it does demonstrate that different methods to accomplish the reducing step are useful.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A method of removing heavy or precious metal ions from an aqueous liquid, said method comprising:
contacting the aqueous liquid with a lignocellulosic material under conditions effective to remove heavy or precious metal ions from the aqueous liquid.

2. The method according to claim 1, wherein the lignocellulosic material is from a plant source.

3. The method according to claim 1, wherein the lignocellulosic material is the product of thermal or earthworm-mediated composting.

4. The method according to claim 1, wherein the lignocellulosic material is an aged hardwood bark.

5. The method according to claim 1, wherein the lignocellulosic material comprises indigestible components of plants that pass through ruminant animals and that are recovered from manures or manures plus bedding materials.

6. The method according to claim 1, wherein the heavy or precious metal ions are from a metal selected from the group consisting of copper, nickel, lead, iron, zinc, cadmium, mercury, uranium, gold, silver, chromium, antimony, other metals having an atomic weight of greater than 58, or mixtures thereof.

7. The method according to claim 1 further comprising:
adjusting the pH of the aqueous liquid to 5.5 or above prior to said contacting.

8. The method according to claim 1, wherein said adjusting the pH is carried out by contacting the aqueous liquid with limestone or an agent effective to neutralize acid waters.

9. The method according to claim 1 further comprising:
reducing metal oxides in the aqueous liquid to cations prior to said contacting.

10. The method according to claim 9, wherein said reducing metal oxides is carried out by contacting the aqueous liquid with a metabisulfite or a ferrous ion.

11. The method according to claim 1 further comprising:
growing plants capable of high transpiration rates proximate to the lignocellulosic material.

12. The method according to claim 11 further comprising:
harvesting the lignocellulosic material and any plants growing proximate to the lignocellulosic material and combusting the harvested material.

13. The method according to claim 11, wherein the plants are willow or cottonwood trees.

14. The method according to claim 1 further comprising:
growing plants capable of accumulating metal proximate to the lignocellulosic material.

15. The method according to claim 14 further comprising:
harvesting the lignocellulosic material and any plants growing proximate to the lignocellulosic material;
combusting the harvested material; and
recovering metals from ash generated by said combusting.

16. The method according to claim 1 further comprising:
growing plants or plant-microbe combinations capable of degrading cyanides or metallocyanides and/or sequestering metals in the presence of water containing cyanide-conjugated metals and proximate to the lignocellulosic material.

17. The method according to claim 16 further comprising:
harvesting the lignocellulosic material and any plants growing proximate to the lignocellulosic material;
combusting the harvested material; and
recovering metals from ash generated by said combusting.

18. The method according to claim 1, wherein the lignocellulosic material preferentially absorbs heavy metal ions over alkali and alkaline earth metal ions.

19. The method according to claim 1, wherein said contacting is carried out in a column, open vessel, trench, berm, or silo containing the lignocellulosic material.

20. The method according to claim 1, wherein the aqueous liquid comprises oil which also is removed by the lignocellulosic material.
